(19) United States
(12) Patent Application Publication
(10) Pub. No.: US 2011/0020761 A1
(43) Pub. Date: Jan. 27, 2011

(54) Orthodontic Repositioning Applicance

(76) Inventor: Thomas Kalili, Beverly Hills, CA (US)

Correspondence Address: BANNER & WITCOFF, LTD., 1100 13th STREET, N.W., SUITE 1200, WASHINGTON, DC, 20005-4051, US

(21) Appl. No.: 12/814,725

(22) Filed: Jun. 14, 2010

Related U.S. Application Data
(63) Continuation-in-part of application No. 11/549,506, filed on Oct. 13, 2006.
(60) Provisional application No. 60/822,991, filed on Aug. 21, 2006.

(51) Int. Cl. A61C 7/08; B23P 13/00; A61C 9/00

(52) U.S. Cl. 433/6; 29/896.11; 433/214

(57) ABSTRACT

An invisible removable orthodontic repositioning appliance with a lower modulus inner lining for systematically aligning teeth from an initial tooth arrangement to a final tooth arrangement while minimizing propensity for root and bone resorption due to the lower modulus is disclosed. The aligning of the teeth may be accomplished by taking impressions at various intervals for greater accuracy in the event of a distorted impression. Patient impression and/or model may then be digitally scanned. Using 3D software, tooth position may be incrementally modified toward idealized position and associated stress analyzed. Final modified model and associated appliance may be fabricated for orthodontic movement using 3D printing. Each appliance may be numerically identified to maintain uniformity of application from start of treatment to completion. The forces required for the alignment may be from polymeric material used to fabricate the orthodontic appliances, the shape memory alloy, and/or micro-implants to accomplish optimal tooth movement.

This application is a continuation-in-part of U.S. application Ser. No. 11/549,506, filed on Oct. 13, 2006, which claims the benefit of U.S. Provisional Application No. 60/822,991 filed Aug. 21, 2006, both of which are incorporated herein by reference in their entirety.

### BACKGROUND

Orthodontic treatments involve repositioning misaligned teeth and improving bite configurations for improved cosmetic appearance and dental function. Repositioning teeth is accomplished by applying controlled forces to the teeth over an extended period of time.

Currently, there are numerous techniques for orthodontic treatments for repositioning misaligned teeth and improving bite configurations. The conventional technique consists of requiring the patient to wear what are commonly referred to as “braces.” Braces comprise a variety of appliances such as brackets, bands, arch wires, ligatures, and O-rings. After they are bonded to the teeth, periodic meetings with the orthodontist are required to adjust the braces. This involves installing different arch wires having different force-inducing properties or by replacing or tightening existing ligatures. Between meetings, the patient may be required to wear supplementary appliances, such as elastic bands or headgear, to supply additional or extra oral forces. Conventional braces are often a tedious and time consuming process requiring many visits to the orthodontist's office. Moreover, from a patient's perspective, they are unsightly and uncomfortable. Braces can be formed using a shape memory alloy (“SMA”). For example, George Andreasen in 1972 developed the nitinol archwire. The nitinol archwire can be used to exert a constant tooth-moving force on the teeth.

Another group of appliances are removable orthodontic appliances, which have been used since the early 20th century. One such appliance in this group is a tooth positioning appliance, as disclosed in U.S. Pat. No. 2,531,222. The tooth positioning appliance is one piece that moves the upper and lower teeth simultaneously. This type of appliance is very demanding on patients as it is bulky, uncomfortable, and prevents patients from speaking. Also in this group are appliances known as spring-alignment appliances. These appliances are designed to correct minor incisor rotations. This appliance is constructed over a model of the repositioned teeth. Labial and lingual wires are formed and labial and lingual plates are formed over the wires. The acrylic plates apply the pressure to the teeth. These appliances cannot be adjusted and are not particularly effective for tooth movement.

Consequently, alternative orthodontic treatments have been developed. Recent patents, including U.S. Pat. No. 6,454,565 by inventor Phan and U.S. Pat. No. 6,790,036 by inventor Graham relies on the use of elastic positioning appliances for realigning teeth. In these alternative treatments an inner elastic modulus is significantly higher than the outer elastic modulus thereby creating greater potential for excess and localized force which in turn possesses greater propensity to cause iatrogenic damage to patient's teeth, dental roots, and periodontum. Although during routine orthodontic dental movement it is necessary to cause some resorption and apposition, otherwise teeth cannot move, one must limit such degradation of anatomical structure to thereby minimize the ultimate loss of teeth. The increased modulus to the inner aspect of the appliance does the opposite of what a periodontist (specialist in bone, soft tissue and dental health) wishes for any patient. Thus, there is a need in the art for an apparatus and method providing orthodontic treatments without causing periodontal destruction which is not necessary for dental movement.

### SUMMARY

The summary is provided to introduce a selection of concepts in a simplified form that are further described below in the detailed description. This summary is not intended to identify key features or essential features of the subject matter, nor is it intended to be used to limit the scope of the subject matter.

An aspect of the invention relates to an invisible removable orthodontic repositioning appliance with a lower modulus inner lining for systematically aligning teeth from an initial tooth arrangement to a final tooth arrangement while minimizing propensity for root and bone resorption.

In another aspect of the invention relates to an invisible removable orthodontic repositioning appliance with an option to have incorporated in it Shape Memory Alloy (SMA) which is an alloy used in the aeronautic industry where once the material shape is set the material may be severely deformed and then returned to its original shape.

In another aspect of the invention, a repositioning appliance may be constructed from polymers with a lower elastic modulus inner lining than the outer lining. The lower elastic modulus on the inner layer may allow for greater patient comfort, less tooth, bone and root damage, and longer duration of tooth movement by the repositioning appliance thereby requiring less number of appliances to achieve the same or similar orthodontic alignment.

In another aspect of the invention, a separate scan may be required for a patient's upper, maxillary, teeth or for a patient's lower, mandibular, teeth. This is only required under conditions where the case does not fit and all other trouble shooting issues have been exhausted.

In an additional aspect of the invention, a separate mold may be taken of the patient's teeth at various intervals in the alignment process, and a new repositioning appliance may be made based on such molds. By creating numerous molds, a defect in one mold may not continue throughout the course of the patient's treatment. Each of the molds and associated appliances may be numerically identified to maintain uniformity of application from start of treatment to completion.

In a further aspect of the invention, the repositioning appliance may comprise one or more raised portions or surfaces that may provide greater force, control and surface to surface retention over a patient's teeth. For example, the appliance can be provided with one or more raised surfaces. As discussed above, the raised surfaces may possess various sizes, depths and shapes on the internal aspect of the aligner depending on the type of orthodontic tooth movement required such as a rectangular or bar shape, a circle shape, or a star shape at perpendicular to the tooth long axis, parallel, diagonal or a combination thereof to cause the desired force for proper tooth alignment. Other shapes are also contemplated. Additionally, a space may be created on the opposing side of the raised surfaces by pulling back on the tooth of the digital file where indentations were placed. Upon aligner fabrication, this will create a space on the opposing side of the raised surface to provide an area for the tooth to move into as the raised portion decompresses. The raised portions causes increased: pressure, control and retention when the aligner is inserted over the patient's teeth. Once the appliance is inserted over the patient's dentition, the raised surfaces contact with the patient's teeth and begin to recover causing one or more of the patient's teeth to move in a predetermined controlled manner.

In a further aspect of the invention, traditionally clear aligners are intended for adults since children are in mixed dentition and the loss and eruption of teeth would alter the overall patient's dental arch each time there is a change. Therefore, the repositioning appliance may comprise “window(s) relief areas” on the occlusal surface of the aligner for areas which patient still possesses primary dentition. Therefore, the aligner will not affect or alter the areas of the patient's arch which are in transition phase, i.e.: mixed dentition where primary teeth fall out and permanent teeth erupt in their place. These windows will enable much less impression requirements to achieve accurate aligner fabrication and orthodontic tooth movement.

Following the insertion of the indentations in areas where tooth movement is required and associated pull backs of the teeth on the opposing sides of the indentation, the orthodontic aligner can be fabricated using various CAD/CAM techniques.

In a first process, a model of the digital file is printed using rapid prototype 3D printers. A polymer sheet is heated and vacuumed over the printed model. The internal aspect of the polymer sheet adapts into the indentations of the printed model which translate into raised surfaces on the internal aspect of the orthodontic aligner. On the opposing side of the indentations, space is provided by pulling the tooth back, such that when the polymer sheet is vacuumed over the model, it creates additional room on the opposing side for tooth to move into.

In a second alternative process, fabrication of aligner and associated indentations on the internal aspect of the aligner may also be accomplished by directly milling the aligner off of the modified digital file which consists of the indentations and pull backs on the opposing side of the indentations.

### BRIEF DESCRIPTION OF THE DRAWINGS

FIG. 1 illustrates an occlusal view of a maxillary impression taken from a patient with anterior crowding prior to any treatment in accordance with an aspect of the invention.

FIG. 2 illustrates an occlusal view of a maxillary stone model which has been poured from the maxillary impression in accordance with an aspect of the invention.

FIG. 3 illustrates an occlusal view of a maxillary repositioning appliance which has been fabricated from the modified stone model referenced in FIG. 2 in accordance with an aspect of the invention.

FIG. 4 illustrates an occlusal view of the repositioning appliance on the maxillary model referenced in FIG. 2 in accordance with an aspect of the invention.

FIG. 5 illustrates an occlusal view of the maxillary stone model in FIG. 2, where the anterior teeth have been sequentially modified toward their idealized tooth position in accordance with an aspect of the invention.

FIG. 6 illustrates an occlusal view of a mandibular impression taken from a patient with anterior crowding in accordance with an aspect of the invention.

FIG. 7 illustrates an occlusal view of the mandibular stone model which has been poured from the mandibular impression, referenced in FIG. 6 in accordance with an aspect of the invention.

FIG. 8 illustrates an occlusal view of the mandibular repositioning appliance which has been fabricated from the modified stone model in accordance with an aspect of the invention.

FIG. 9 illustrates an occlusal view of the repositioning appliance on the mandibular model referenced in FIG. 7 in accordance with an aspect of the invention.

FIG. 10 illustrates an occlusal view of the mandibular stone model in FIG. 7, where the anterior teeth have been slightly modified toward their idealized positions in accordance with an aspect of the invention.

FIG. 11 illustrates an occlusal diagrammatic view of a patient's maxillary teeth where the anterior teeth have been sequentially aligned in accordance with an aspect of the invention.

FIG. 12 illustrates an occlusal diagrammatic view of a patient's maxillary teeth of FIG. 11 following use of the repositioning appliance where the anterior teeth have been partially aligned from a subsequent patient impression in accordance with an aspect of the invention.

FIG. 13 illustrates an occlusal diagrammatic view of a patient's mandibular teeth of where the anterior teeth have been partially aligned, in accordance with an aspect of the invention.

FIG. 14 illustrates an occlusal diagrammatic view of a patient's mandibular teeth of FIG. 13 following the use of the repositioning appliance where the anterior teeth have been partially aligned from a subsequent patient impression in accordance with an aspect of the invention.

FIGS. 15 and 16 illustrate schematic drawings representing the difference between low modulus (softer) inner aspects of the appliance compared to a higher modulus (harder) appliance at the tooth—appliance interface in accordance with an aspect of the invention.

FIG. 17 illustrates stress distributions in laminated and un-laminated repositioning appliances in accordance with an aspect of the invention.

FIG. 18 illustrates grooves that may be used in various embodiments of a repositioning appliance in accordance with an aspect of the invention.

FIG. 19A depicts an exemplary embodiment of an appliance.

FIG. 19B depicts another exemplary embodiment of an appliance.

FIG. 20A shows an isometric view of a model used to form an appliance.

FIG. 20B shows an isometric view of another model used to form an appliance.

FIGS. 21A and 21B depict an exemplary embodiment of modeling software used to form various appliances.

FIG. 22 depicts another exemplary embodiment of modeling software used to form various appliances.

FIG. 23 depicts a rapid prototyping printer used to create various models and appliances.

FIG. 24 depicts a schematic illustrating an exemplary embodiment of an appliance compared to a conventional orthodontic spring.

FIG. 25 depicts a graph comparing an exemplary embodiment of an appliance to a conventional orthodontic spring.

FIG. 26 depicts a conventional orthodontic spring in a patient's mouth used for realigning the patient's teeth.

FIG. 27 depicts a patient's mouth where the appliance is used for realigning the patient's teeth.

FIGS. 28A and 28B depict schematics of tooth and aligner according to another embodiment.

FIG. 29 depicts an aligner according to another embodiment.

FIG. 30 depicts an assortment of exemplary raised surfaces that may be used in conjunction with an aligner.

FIG. 31 depicts an aligner according to another embodiment.

FIG. 32 depicts an impression another embodiment.

FIG. 33 depicts an aligner formed from the impression depicted in FIG. 32.

### DETAILED DESCRIPTION

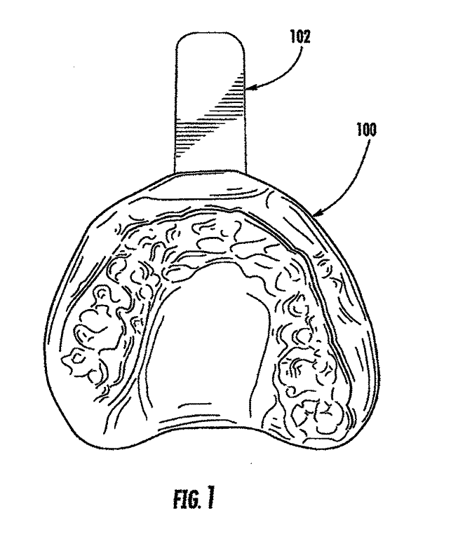

FIG. 1 illustrates an occlusal view of a maxillary impression 100 taken from a patient with anterior crowding. A maxillary impression 100 is an impression made of a patient's upper teeth. Anterior crowding is crowding of the front teeth. The maxillary impression 100 may be removed from the patient's mouth using tab 102.

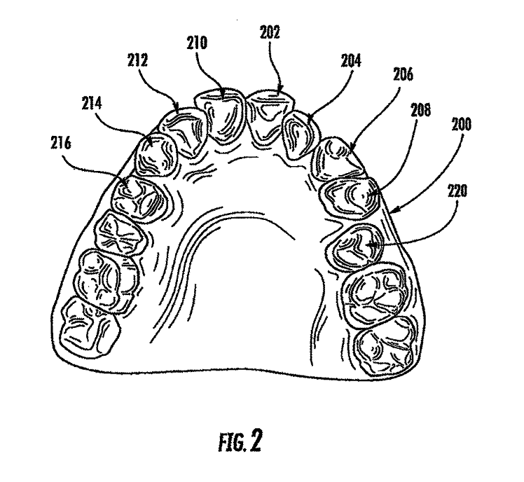

A maxillary stone model 200 of the patient's maxillary teeth may be made using the maxillary impression 100, as seen in FIG. 2. The stone model 200 of the maxillary impression 100 may be modified to create an appliance that will alter and align the patient's teeth. In FIG. 2, the anterior teeth 202, 204, 206, 208, 210, 212, 214, 216, and posterior (rear) tooth 220 are not aligned.

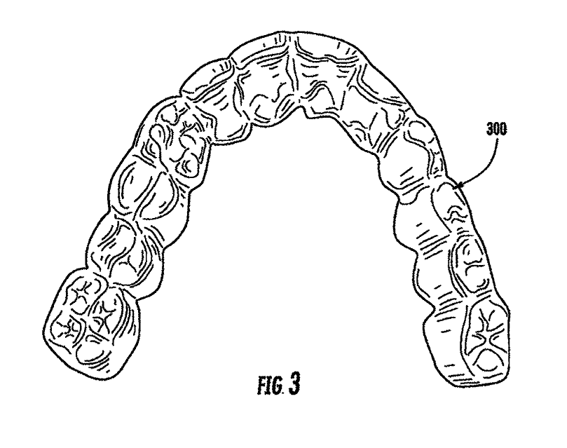

FIG. 3 illustrates maxillary repositioning appliance 300 that may be fabricated from a maxillary stone model. Maxillary repositioning appliance 300 may be the first repositioning appliance in a series of appliances that may be used to reach the alignment goal. Repositioning appliance 300 may be comprised of a single sheet of material that may be formed from a variety of materials, such as polymers and plastics including polycarbonates, polyacetates, polyolefins, polyamides, polystyrenes and epoxy resins among others. These materials may range in thickness from 0.020 inch to 0.20 inch, depending upon the material's physical characteristics. In an aspect of the invention, repositioning appliance 300 may be 0.030 inch thick polycarbonate with a lower modulus inner lining which has been thermo vacuum-formed over a model 406 of a patient's teeth. The polycarbonate with a lower modulus inner lining is tissue compatible and invisible making it aesthetically appealing to the patient during use. Those skilled in the art will realize that materials such as polycarbonates, polyacetates, polyolefins, polyamides, polystyrenes and epoxy resins among others also may be provided in clear forms. The 0.030 inch repositioning appliance 300 may be firm enough to move the patient's teeth and may be flexible enough to adapt to the patient's misaligned teeth. These characteristics may provide a sequential adjustment of the teeth from a new impression at each and every phase toward the ideal that will move the patient's teeth from misalignment to alignment on an incremental basis with each and every new impression taken at each treatment interval of about six weeks. Those skilled in the art will realize that treatment intervals may be shorter or longer than six weeks depending upon a variety of patient and treatment factors.

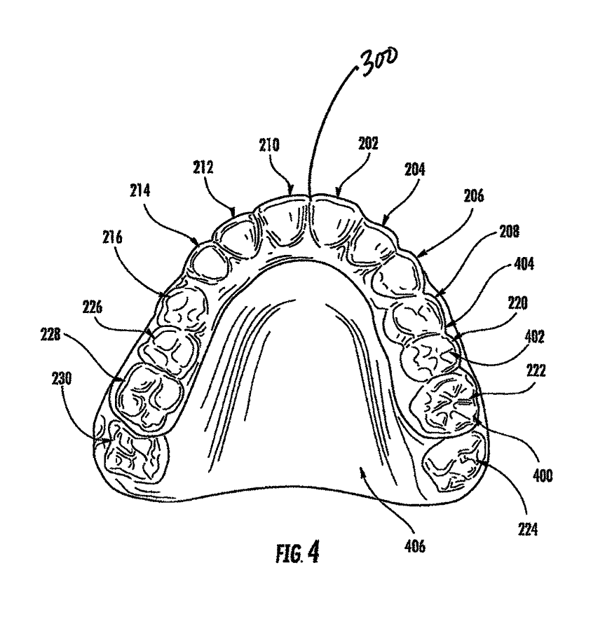

FIG. 4 illustrates maxillary repositioning appliance 300 over modified maxillary stone model 406. As shown in FIG. 4, maxillary repositioning appliance 300 does not have to extend over all maxillary teeth 400. Repositioning appliance 300 may be formed over a patient's teeth 402 and adjacent soft tissue 404. In an aspect of the invention, repositioning appliance 300 may have its best use when only the anterior teeth 202, 204, 206, 208, 210, 212, 214, 216 require aligning and the posterior teeth 220, 222, 224, 226, 228, 230, requiring no alignment, become an anchor for the repositioning appliance 300. In an alternative embodiment, with other teeth acting as an anchor, the repositioning appliance 300 may be used to align posterior teeth 220, 222, 224, 226, 228, 230.

The process of taking a maxillary impression, creating a stone model, modifying that stone model to form a more ideal teeth alignment model, and creating a maxillary repositioning appliance may occur about every six weeks until the patient's teeth are in alignment but other durations and variations are also contemplated.

In an aspect of the invention, the repositioning appliance may be created using a 3-D scanner and printer. When using 3-D technology to fabricate a repositioning appliance, there may be greater accuracy using laminated aligners with soft inner lining then un-laminated aligners as the repositioning appliance with laminated soft liners demonstrates less stress in the supporting bone then un-laminated aligners when inserting over an un-orthodontically altered model.

A further aspect of the invention is that, the increased flexibility of the internal lining allows for a greater tolerance of error. In other words, the greater flexibility will be more forgiving than an unlaminated aligner, which is stiffer throughout and does not have the ability to flex or adapt to the patient's dentition.

In an aspect of the invention, posterior teeth 220, 222, 224, 226, 228, 230 which may not require alignment may act as anchors for repositioning appliance 300 for use in aligning anterior teeth 204, 206, 208, 210, 212, 214, and 216.

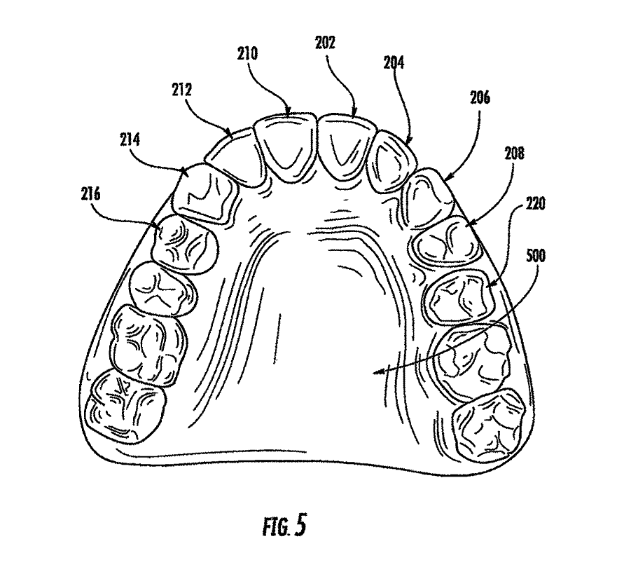

FIG. 5 illustrates a maxillary stone model 500, which has been sequentially modified from an impression made subsequent to use of a number of repositioning appliances, each designed to increasingly align the patient's teeth. As shown on stone model 500, the patient's teeth 202, 204, 206, 208, 210, 212, 214, 216, 220 are much more aligned than they had been in the initial modified maxillary stone model 200. Maxillary stone model 500 has been modified to a more ideal alignment, and it may be used to create a subsequent maxillary repositioning appliance.

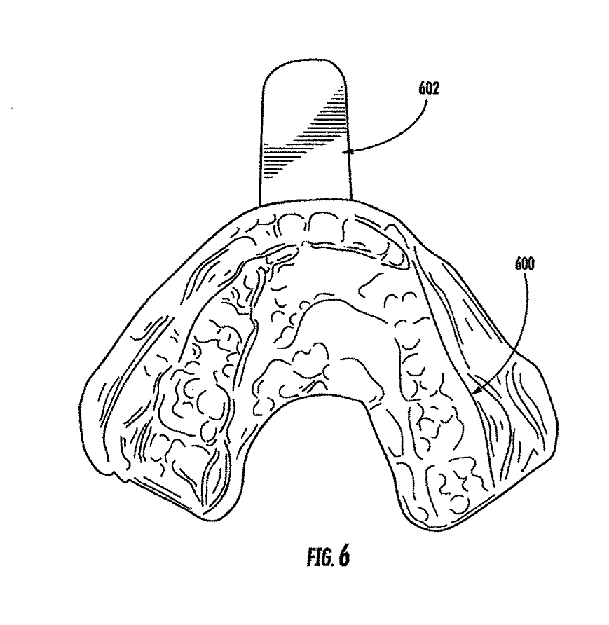

The entire process may also be done to the mandibular (lower) teeth. FIG. 6 illustrates an occlusal view of a mandibular impression 600 taken from a patient with anterior crowding. A mandibular impression 600 is an impression made of a patient's lower teeth. Anterior crowding is crowding of the front teeth. The mandibular impression 600 may be removed from the patient's mouth using tab 602.

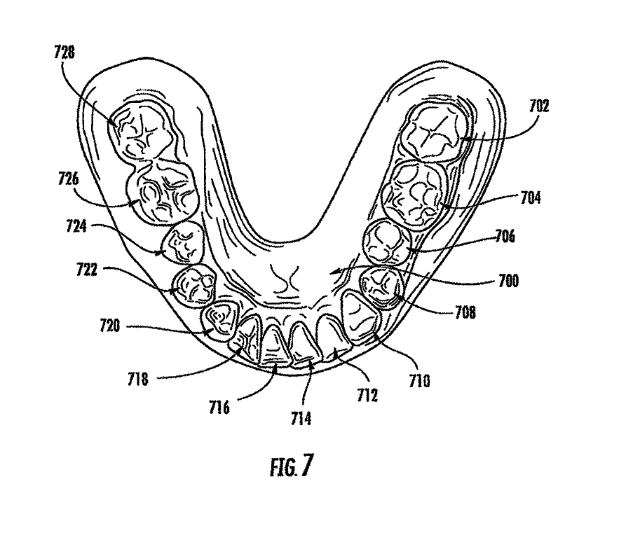

A mandibular stone model 700 of the patient's mandibular teeth may be made using the mandibular impression 600, as shown in FIG. 7. The mandibular stone model of the mandibular impression 600 may be modified to create an appliance that may alter and align the patient's teeth. FIG. 7 illustrates that the patient's teeth 702, 704, 706, 708, 710, 712, 714, 716, 718, 720, 722, 724, 726, 728 are not aligned.

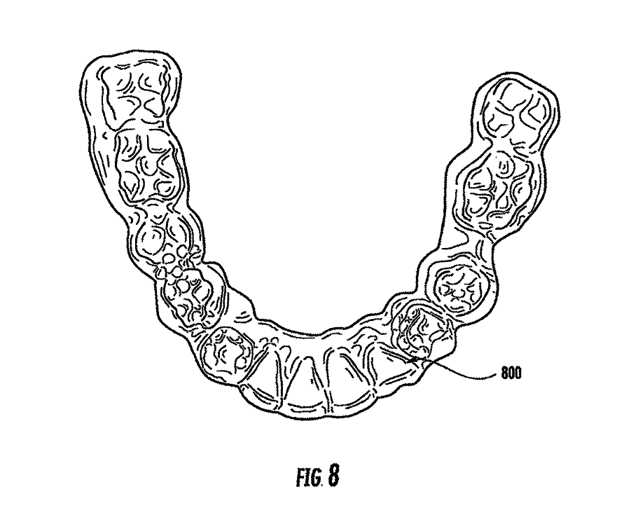

FIG. 8 illustrates a mandibular repositioning appliance 800 that may be fabricated from a mandibular stone model. The repositioning appliance 800 may be the first repositioning appliance in a series of appliances that may be used to reach the alignment goal. The repositioning appliance 800 may be comprised of a single sheet of material that may be formed from a variety of materials, such as polymers and plastics including polycarbonates, polyacetates, polyolefins, polyamides, polystyrenes and epoxy resins among others. These materials may range in thickness from 0.020 inch to 0.20 inch, depending upon the material's physical characteristics.

In an aspect of the invention, the repositioning appliance 800 may be 0.030 inch thick polycarbonate with a lower modulus inner laminate which has been thermo vacuum-formed over a model 906 of a patient's teeth. The polycarbonate with a lower modulus inner laminate is tissue compatible and invisible which making it aesthetically appealing to the patient during its use. Those skilled in the art will realize that materials such as polycarbonates, polyacetates, polyolefins, polyamides, polystyrenes and epoxy resins among others may also be provided in clear forms. The 0.030 inch repositioning appliance 800 may be firm enough to move the patient's teeth and may be flexible enough to adapt to the patient's misaligned teeth. These characteristics provide a sequential adjustment of the teeth from a new impression at each and every phase toward the ideal that will move the patient's teeth from misalignment to alignment on an incremental basis with each and every new impression taken at each treatment interval of about six weeks. Those skilled in the art will realize that treatment intervals may be shorter or longer than six weeks depending upon a variety of patient and treatment factors.

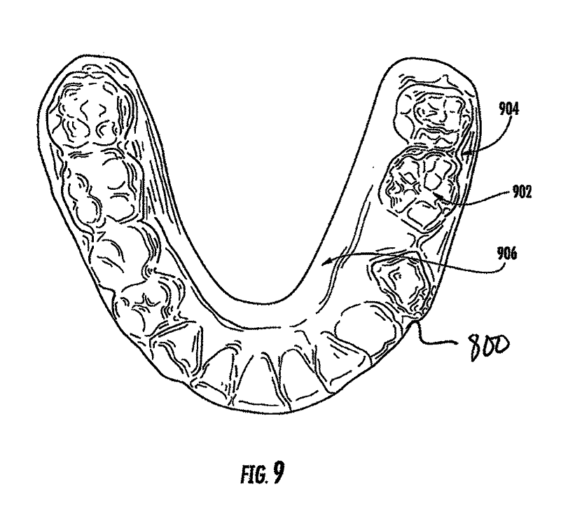

FIG. 9 illustrates mandibular repositioning appliance 800 over modified maxillary stone model 906. Repositioning appliance 800 may be formed over a patient's teeth 902 and adjacent soft tissue 904.

The process of taking a mandibular impression, creating a stone model therefrom, modifying that stone model into a more ideal alignment, and creating a mandibular repositioning appliance may occur at an interval of six weeks until the patient's teeth are in ideal alignment. Those skilled in the art will realize that the interval may be longer or shorter depending upon a variety of patient and treatment factors.

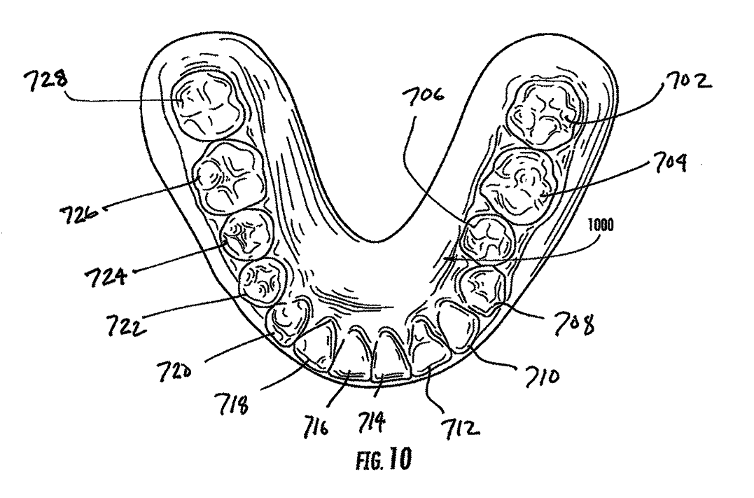

FIG. 10 illustrates a mandibular stone model 1000, which has been sequentially modified from an impression made subsequent to use of a number of repositioning appliances, each designed to increasingly align the patient's teeth. As seen on stone model 1000, the patient's teeth 702, 704, 706, 708, 710, 712, 714, 716, 718, 720, 722, 724, 726, 728 are much more aligned than they had been in the initial modified maxillary stone model 700. Mandibular stone model 1000 has been modified to a more ideal alignment, and it may be used to create a subsequent mandibular repositioning appliance.

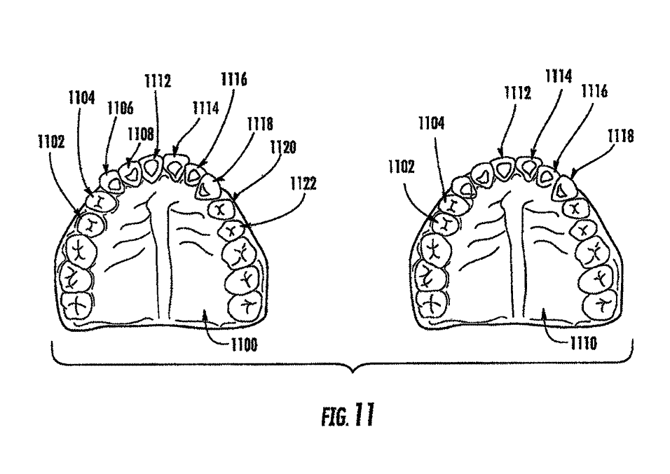

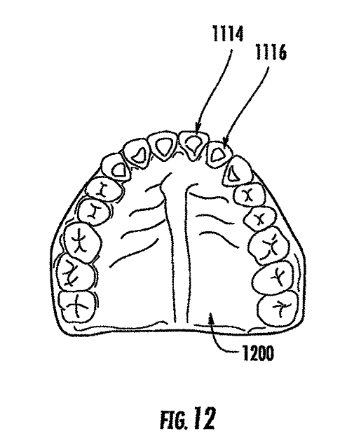

FIGS. 11 and 12 are diagrammatic views of a patient's maxillary teeth at sequential stages in the process of aligning the teeth to the ideal position. The diagram of the initial teeth 1100 shows unaligned teeth. Teeth 1102, 1104, 1106, 1108, 1112, 1114, 1116, 1118, 1120, 1122 are protruding and crooked. In the subsequent diagram 1110, the patient's teeth show improved alignment. The anterior incisor central teeth 1112, 1114 are less protruding, and anterior teeth 1102, 1104 are more aligned. Furthermore, anterior teeth 1116, 1118 show less overlap. In another more subsequent diagram 1200, the patient's teeth show further improvement. The teeth are in alignment and there is less overlap in anterior teeth 1114, 1116.

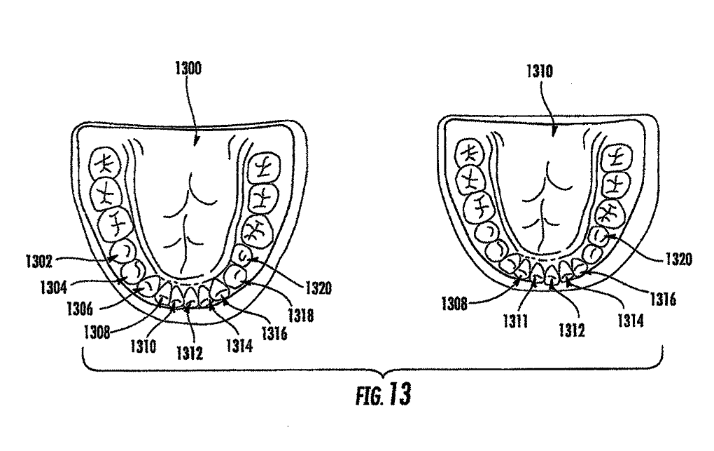

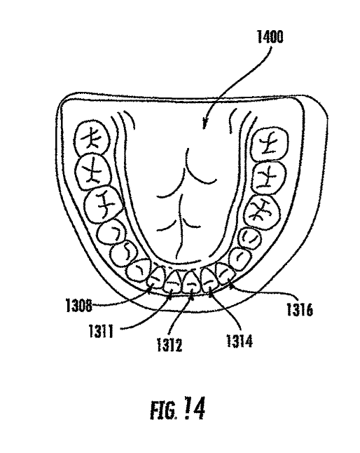

FIGS. 13 and 14 are diagrammatic views of a patient's mandibular teeth at sequential stages in the process of aligning the teeth to the ideal position. The diagram of the initial teeth 1300 shows unaligned teeth. Teeth 1302, 1304, 1306, 1308, 1311, 1312, 1314, 1316, 1318, 1320 are overlapping and crooked. In the subsequent diagram 1310, the patient's teeth show improved alignment. Teeth 1308, 1311, 1312, 1314, 1316 are less overlapping, and tooth 1320 is significantly more aligned with the other teeth. In another more subsequent diagram 1400, the patient's teeth show further improvement. The teeth are in alignment and there is even less overlap in teeth 1308, 1311, 1312, 1314, 1316.

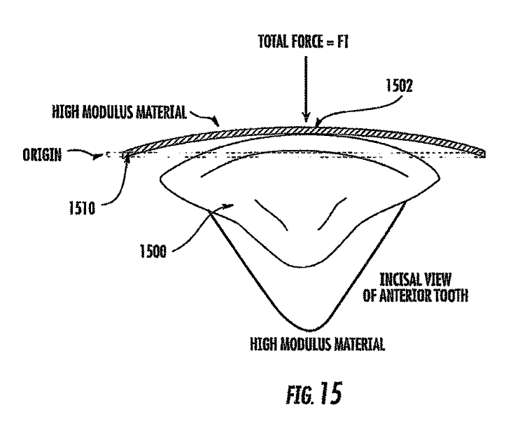

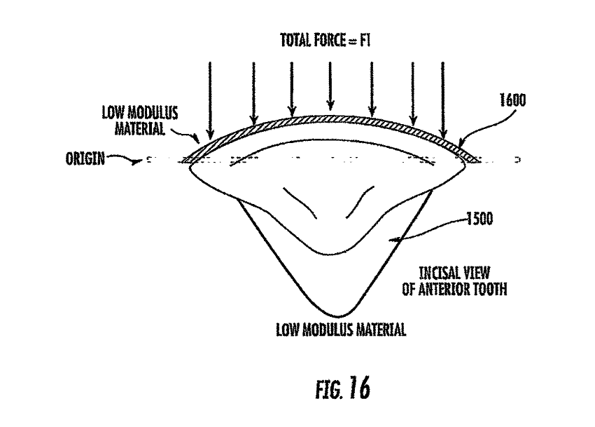

FIGS. 15 and 16 illustrate the benefits of having an inner layer with a lower elastic modulus than the outer layer. The elastic modulus of a material is the ratio of the increment of unit stress to an increment of unit deformation within the elastic limit. When a material is deformed within the elastic limit, the coiled polymer chains are stretched reversibly. The magnitude of the elastic modulus may be indicative of the atomic and molecular bonding forces. When the stress is relieved, the material returns to its original shape and therefore the deformation is nonpermanent. Different materials may have different elastic moduli based on their molecular structures. Some materials, such as certain polymers including polycarbonates, polyacetates, polyolefins, polyamides, polystyrenes and epoxy resins among others, may be specially produced to have different elastic moduli while retaining similar chemical compositions by using additives such as silicates, other polymers or fillers among other materials. In an embodiment, the liner may be a polymer such as Thermoplastic Polyurethane that is an aromatic polyether based grade, such as TEXIN® 990R resin with a shore hardness of approximately 90A. The TEXIN® 990R resin may offer outstanding abrasive resistance, impact strength, toughness, structural memory and flexibility. Furthermore, the resin may also provide good hydrolytic stability, microbial resistance, teeth whitening, oral freshness, varied color materials, and exceptional mold release characteristics. Although in one embodiment a polycarbonate outer layer and a polyurethane inner layer is used, the composition could consist of any type of polymers with higher modulus outer layer and a lower modulus inner layer.

In the final appliance the elastic moduli of the different parts will generally range from 0.1 to 10 GigaPascal (GPa), although some parts of the appliance may be outside of this range. The elastic modulus of one part may differ from another part by 10% to 500%, or more.

As shown in FIG. 15, if an appliance 1510 has a higher modulus on the inner layer than the outer layer, the pressure on the tooth 1500 is localized 1502, thereby increasing the propensity for tooth and bone damage. Also, the harder material 1510 is less elastic thereby causing greater load for a shorter period of time with less tooth movement by each appliance.

FIG. 16 demonstrates the effect on tooth 1500 with use of a repositioning appliance 1600 with an inner layer having a lower elastic modulus than the outer layer. The lower modulus inner layer repositioning appliance 1600 allows for the same amount of load to be distributed to a greater surface area of the tooth for less bone and root resorption. Additionally, the lower modulus inner layer repositioning appliance 1600 will give less force for a longer period of time. Therefore, not only is the lower modulus inner lining safer for the patient's teeth, but also, may allow the repositioning appliance to maintain a longer life.

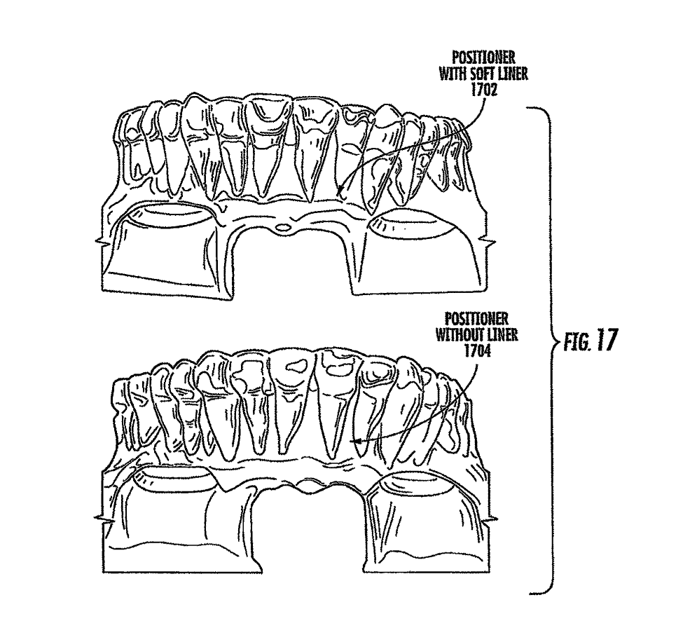

For example, FIG. 17 illustrates the stresses developed at a crestal bone between central incisors with repositioning appliance having an inner layer with a lower elastic modulus than the outer layer as compared to a repositioning appliance without an inner layer (liner).

Polyvinyl siloxane impressions were made and poured up in stone. The central incisors were modified to represent desired orthodontic movement. Two types of repositioning appliances were fabricated from the modified model. The first repositioning appliance was fabricated from a polycarbonate sheet. The second repositioning appliance was fabricated from a polycarbonate sheet laminated with lower modulus polyurethane. The laminated and un-laminated repositioning appliances were inserted on the model and resulting stresses observed in the field of the polariscope and photographed. Stress data for the two repositioning appliances was analyzed using a computer graphics program to quantify stress intensity by fringe number counting.

As shown in FIG. 17, similar stress distributions were developed at the crestal bone between the central incisors with both repositioning appliances. However, the level of stress was significantly lower using the laminated repositioning appliance 1702 as compared to the un-laminated repositioning appliance 1704.

The stresses associated with the laminated repositioning appliance were of lower intensity as compared to the un-laminated repositioning appliance, which may alleviate problems of patient discomfort and difficulty during insertion and removal of un-laminated repositioning appliances.

In another aspect of the invention relates to an invisible removable orthodontic repositioning appliance with an option to have incorporated in it Shape Memory Alloy (SMA) which is an alloy where once the material shape is set the material may be severely deformed and then returned to its original shape. SMAs have good memory characteristics. As the load is decreased on a SMA, the alloy will reshape itself back to its original position. Additionally, when subjected to increased temperatures, SMAs will flex in the direction of their formed position. In one aspect of the invention, an SMA can be incorporated to adapt a newly modified tooth position and inserted into a lingual (inner) aspect of the aligner which seats against the inside portion of the teeth. Once the aligner is inserted, the increased oral temperature activates the SMA to move back to its original position, or the position of the modified dentition. As a result, this added force aids in moving the teeth toward an ideal orthodontic tooth position.

In an embodiment, the SMA may be adapted to an idealized dental alignment and then realigned to the present misaligned dental position and adhered to the polymeric orthodontic shell to allow continual inherent movement of the teeth or adjusted by the dentist. SMA and polymeric technology may allow for two types of cooperating forces toward optimal tooth movement. SMA may be utilized under conditions needing greater force, more rapid movement and or severe cases.

In an aspect of the invention, orthodontic shape memory alloy wire having properties may be adapted to the lingual aspect of a stone model prior to adaptation of the repositioning appliance 1600 thereby allowing continual inherent movement of the patient's teeth. The orthodontic wire may be comprised of an alloy having shape memory properties such as NiTi, CuZnAl, and CuAlNi. Moreover, the orthodontic wire may be adjusted to assist in repositioning of teeth to an optimal position. This adjustment may be a self adjustment or an adjustment based on temperature change.

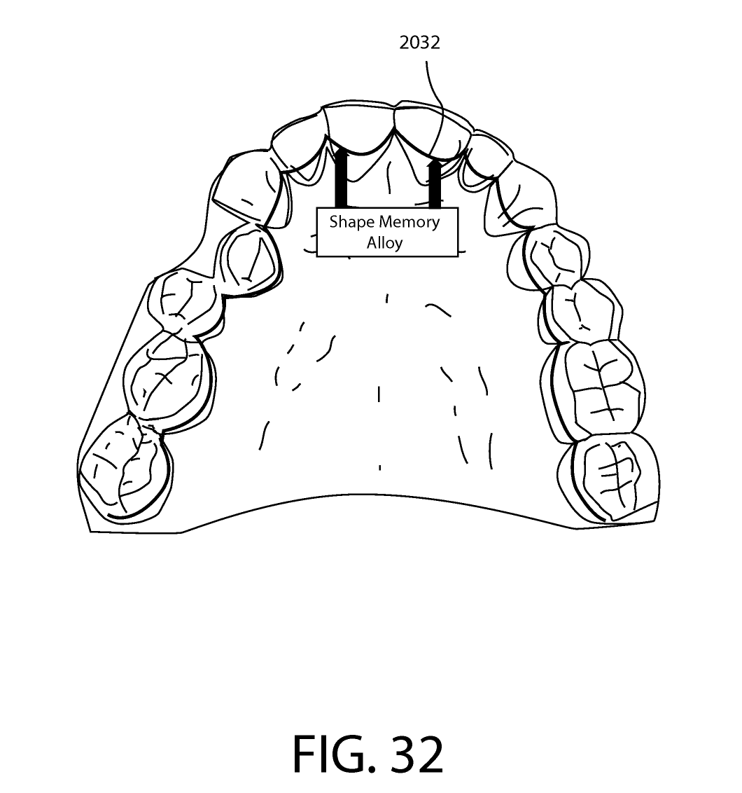

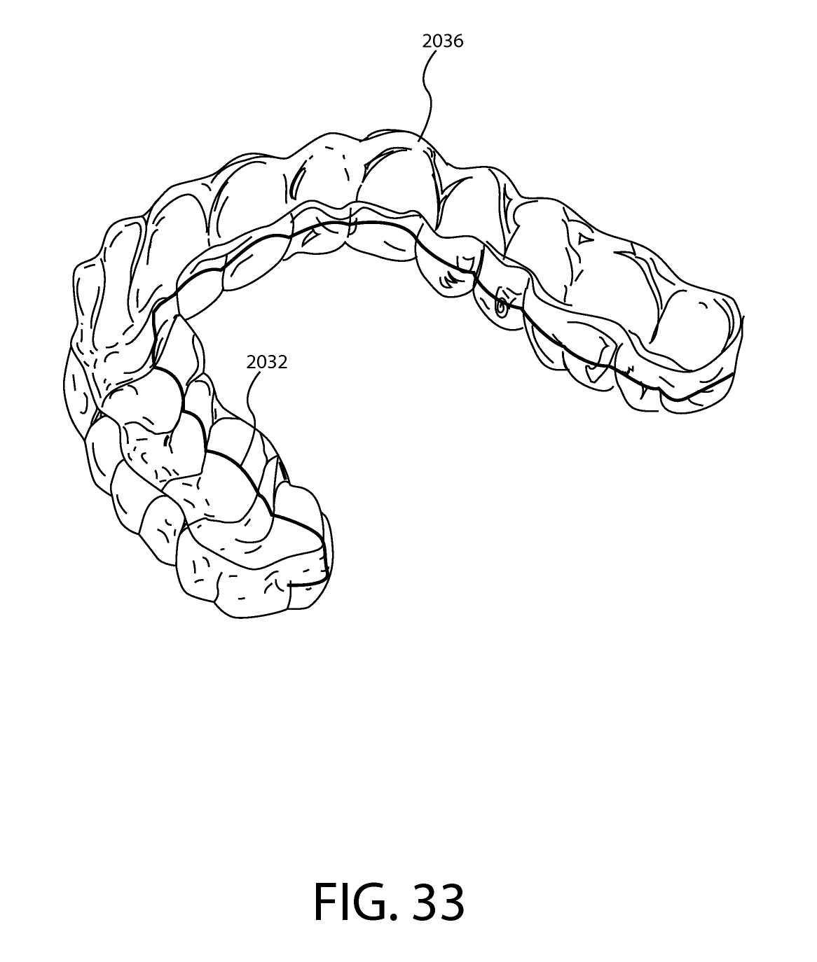

As shown in FIGS. 32 and 33 an SMA wire 2032 can be adapted on the lingual aspect of the digital file and can be incorporated into the aligner 2036 during fabrication. The wire 2032 provides a force causing orthodontic tooth movement. Once an impression is taken of a patient's dentition, the teeth are moved toward an ideal position on the digital file. The wire 2032 can be adapted to the modified digital file on the lingual aspect of the aligner. Upon aligner insertion, the wire 2032 initially adapts to the patient's teeth in the present position. The increased oral temperature activates the SMA wire causing the SMA wire to move toward an ideal position to provide for orthodontic tooth movement.

In yet another aspect of the invention, a micro-implant which may be approximately 1-5 mm in diameter may be utilized. The micro-implant may withstand immediate load unlike traditional implants which may require 6 months of bone integration (healing). The micro-implant may be attached or connected to the polymeric shell or a component of the shell for added orthodontic tooth movement. Micro-implant for orthodontic movement may be achieved by either attachment for example using a Hader-bar, male-female (ball and socket) or magnets to allow for greater force and greater control of orthodontic forces. This may allow for greater options under various orthodontic conditions. A technique for greater orthodontic force and or control may be with magnet attachment at the head (coronal aspect of the micro-implant). The micro-implant may be positioned with the positive pole of the magnet positioned into the bone or tooth for anchorage. The negative pole of the magnet may be imbedded into the SMA, a bracket or component of the polymeric shell or the polymeric matrix of the appliance to allow for greater control and force for orthodontic tooth movement.

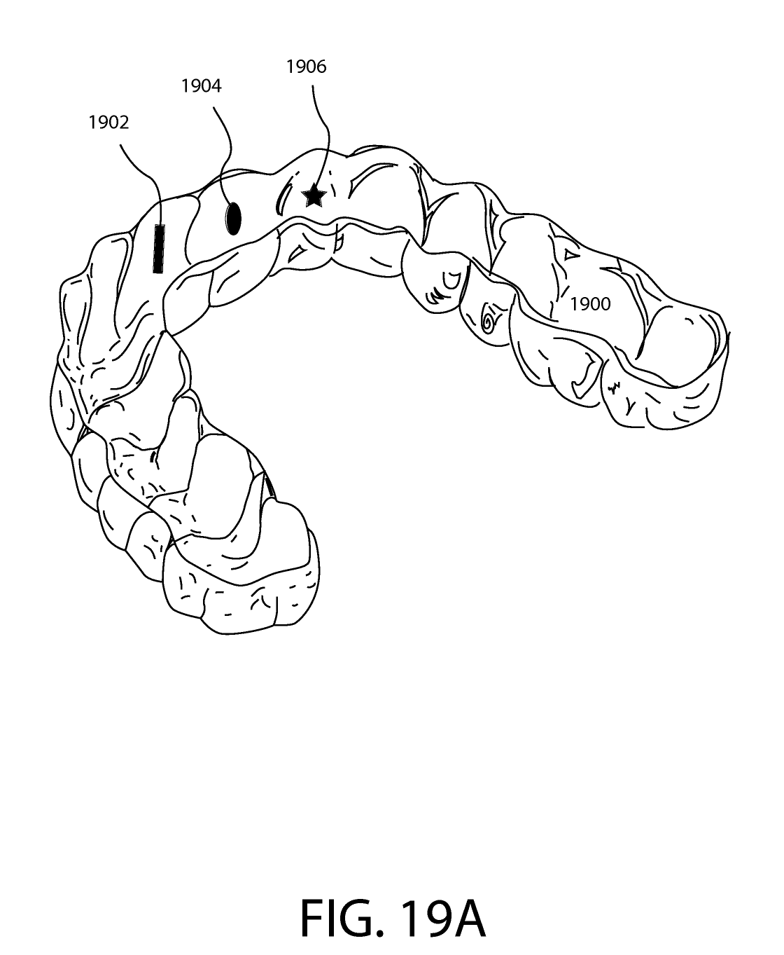

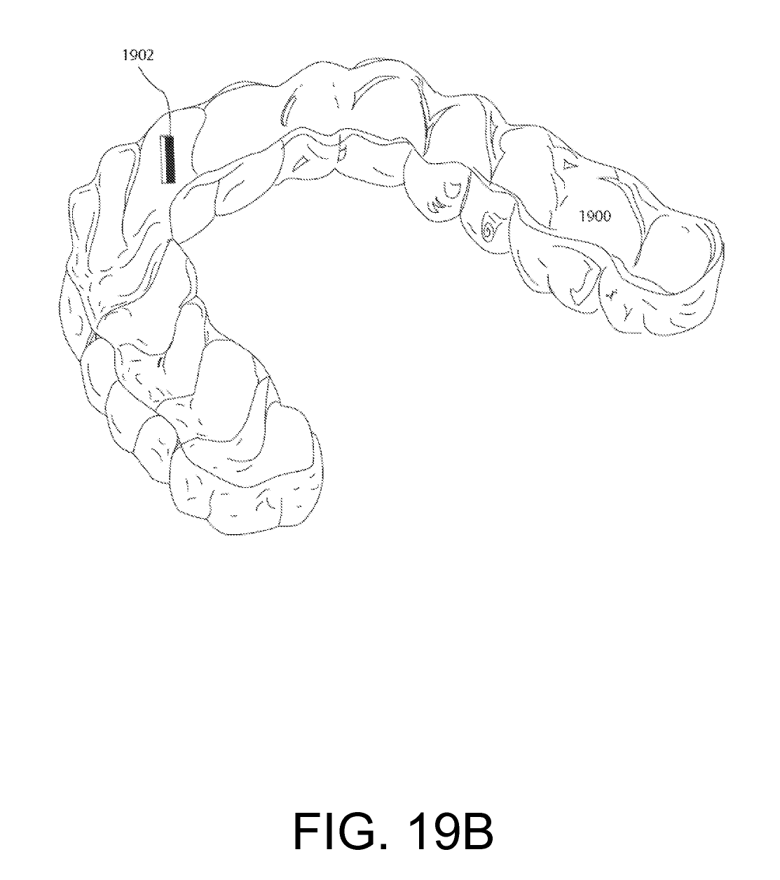

In a further aspect of the invention, the repositioning appliance may comprise one or more raised portions or surfaces that may provide greater control and attachment over a patient's teeth. For example, as shown in FIGS. 19A and 19B, the appliance 1900 can be provided with one or more raised surfaces 1902, 1904, 1906. The raised surfaces can be formed as a rectangular or bar shape 1902, a circle shape 1904, or a star shape 1906. Other shapes are also contemplated. Although the raised surfaces are shown as configured to contact the vestibular surfaces (outer portion) of the teeth, the raised surfaces may also be placed on the lingual surfaces (inner portion) of the teeth. The raised surfaces can be composed of the lower modulus inner layer material of the laminate sheet.

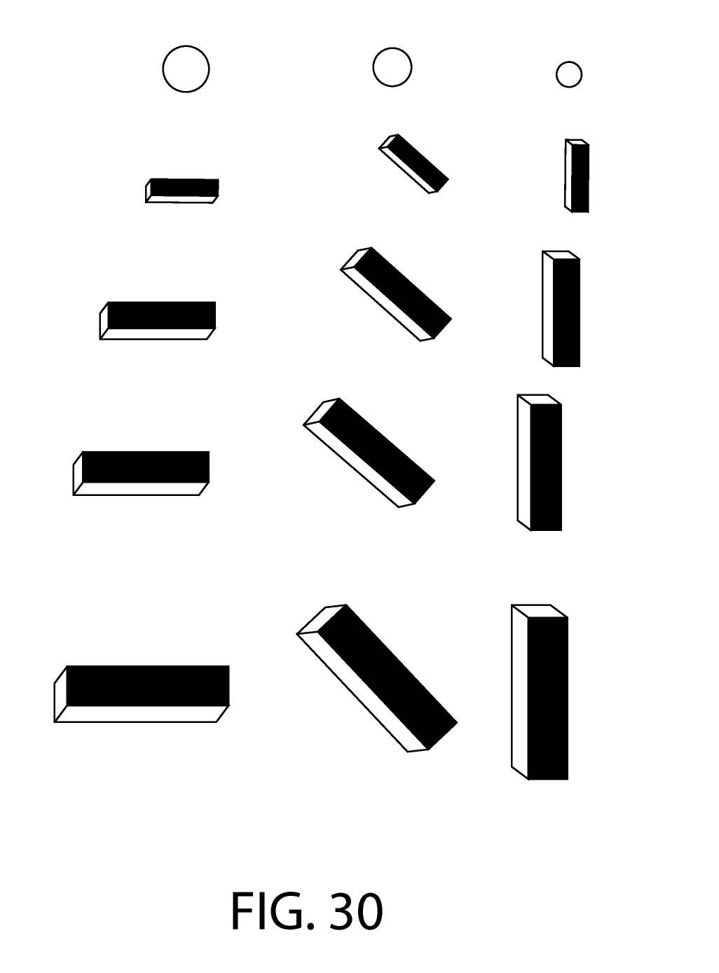

As shown in FIG. 30, the compressible raised surface can be fabricated on the internal aspect of the aligner with varied depth, length, and width depending on the degree and direction of force required for orthodontic tooth movement.

Additionally, a space may be created on the appliance to provide an area for the tooth to move into as the raised portion decompresses. The raised portions increase control of and provide for increased attachment over the patient's teeth. The raised portions are formed of the same material as the inner layer and are configured to compress upon contact with the patient's teeth. Once in contact with the patient's teeth, the raised surfaces will begin to recover causing one or more of the patient's teeth to move in a predetermined controlled manner.

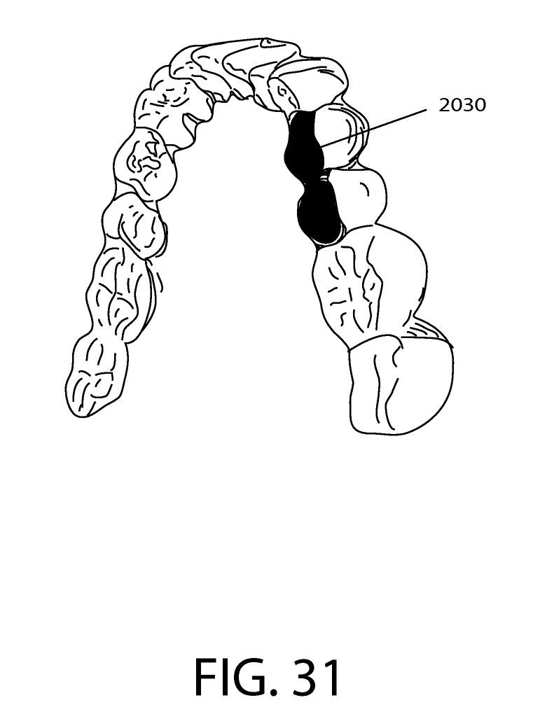

In another exemplary embodiment, the aligner, as shown in FIG. 31 can also be provided with a window on the occlusal surface of the alinger, which can allow for natural changes of the teeth during treatment, such as primary teeth loss followed by the eruption of the permanent dentition.

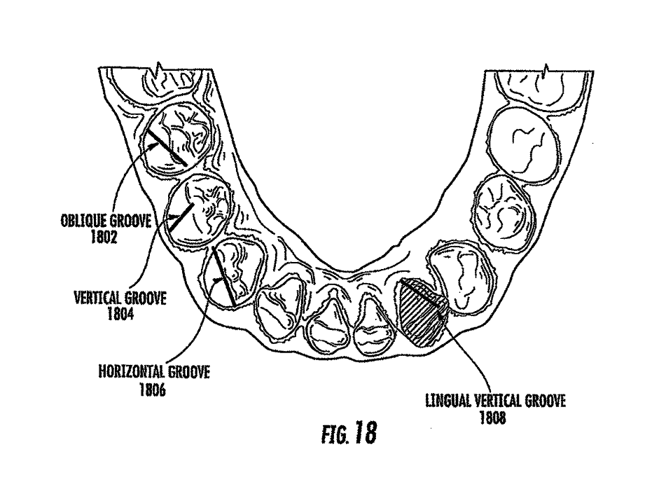

To form the appliance, the technician may outfit the patient's stone model with grooves in areas, which require greater control of force. FIG. 18 illustrates the placement of various grooves such as an oblique groove 1802, a vertical groove 1804, a horizontal groove 1806, and a lingual vertical groove 1808. Those skilled in the art will realize that other geometric shaped grooves such as longitudinal, diagonal, or horizontal grooves may also be used depending upon the type of orthodontic movement. Upon fabrication of the appliance, the grooves become extensions on the appliance to allow for greater control during orthodontic tooth movement.

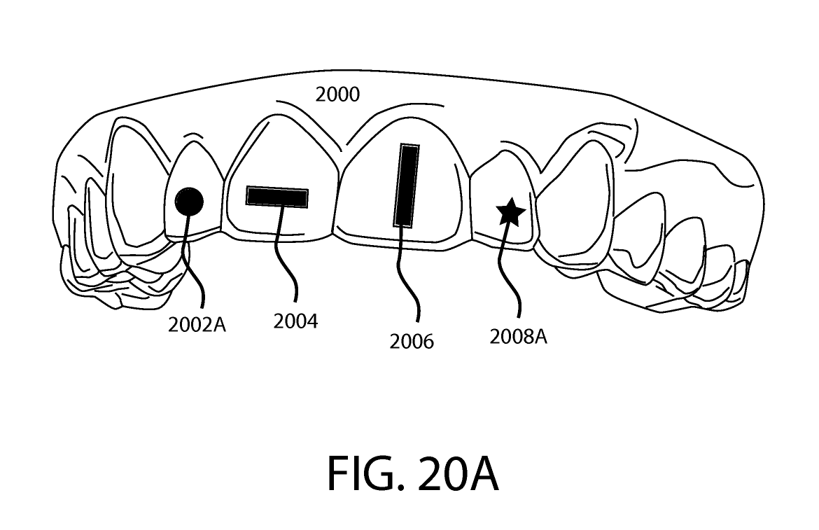

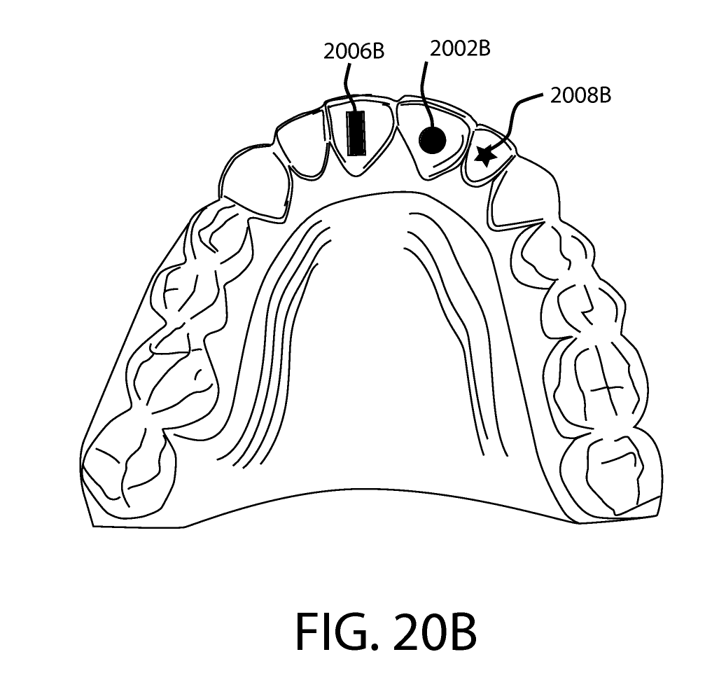

In another embodiment, as shown in FIGS. 20A and 20B, depending on the desired direction of and amount of movement, the technician may outfit the patient's stone model 2000 with any one of: a circle 2002A, 200B, a horizontal rectangle 2004, a vertical rectangle 2006A, 2006B, or a star 2008A, 2008B indent(s) on either the vestibular surfaces (outer portion) or the lingual surfaces (inner portion) including combinations thereof on the patient's model. When the model is used to form the appliance, the indents provide correspondingly shaped and sized raised portions on the appliance.

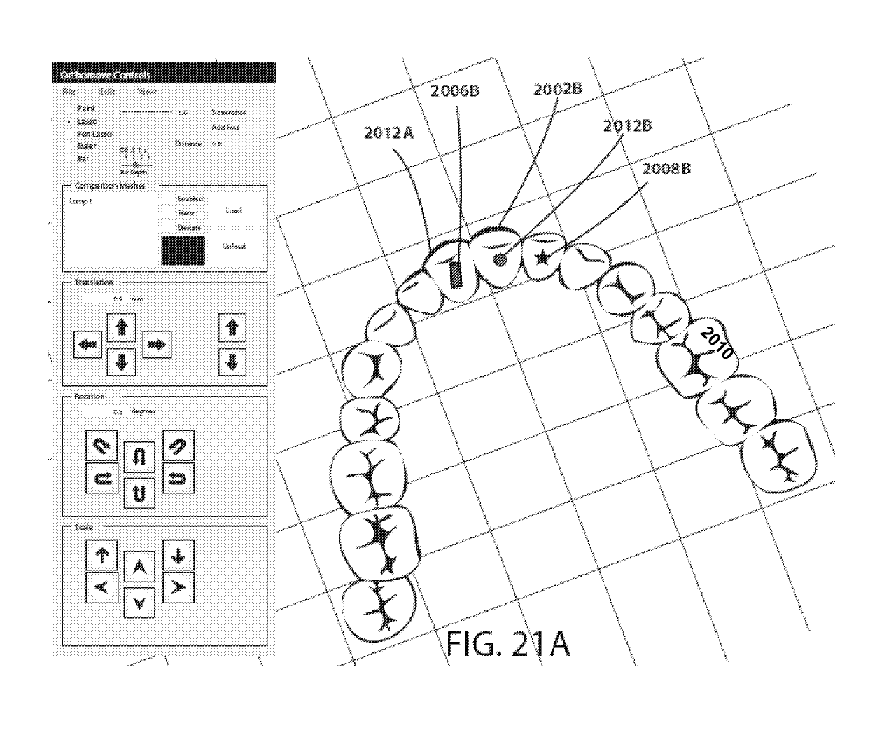

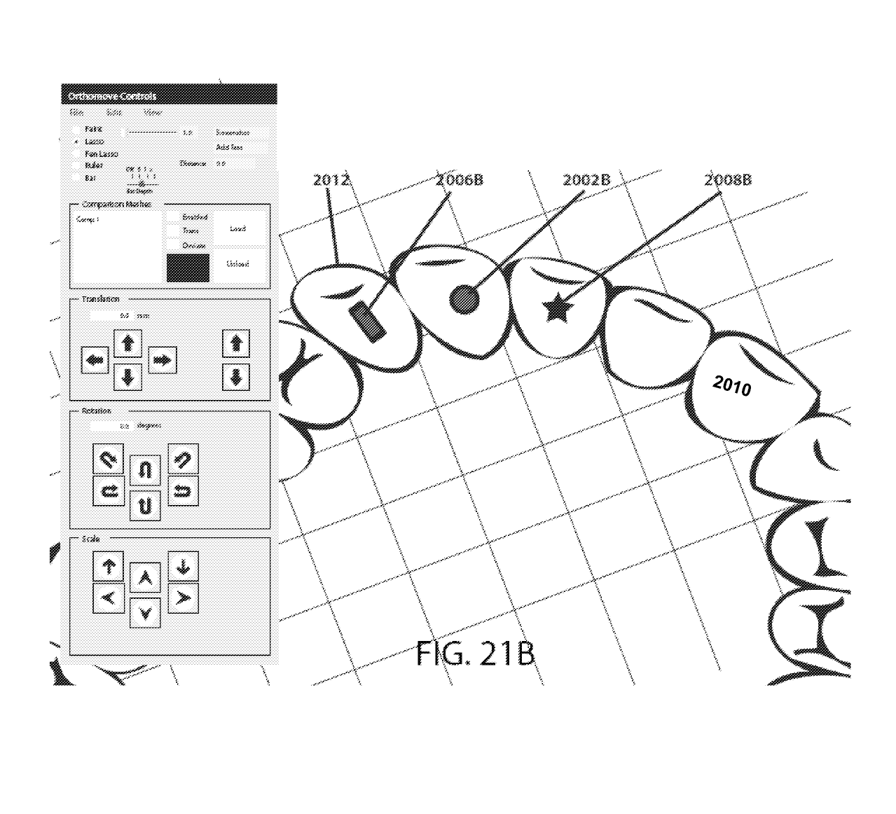

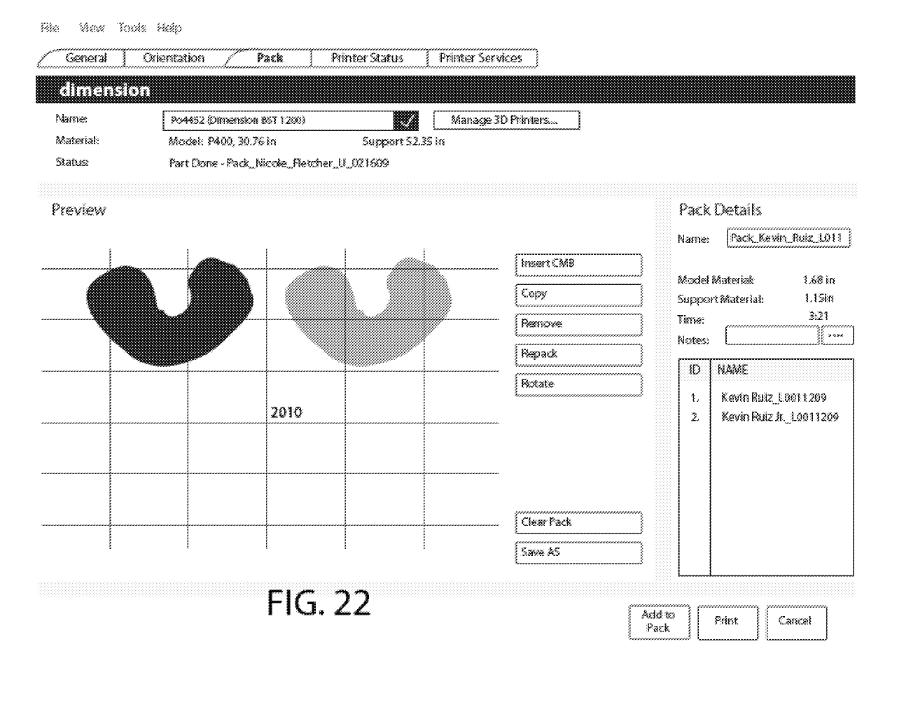

FIGS. 21A, 21B, and 22 depict a process in which indentations or grooves can be placed on the patient's digital file. The technician may outfit the indent(s) on either the vestibular surfaces (outer portion) or the lingual surfaces (inner portion) including combinations thereof on the patient's digital file 2010 depending on the desired movement of the teeth or tooth. As shown in FIGS. 21A and 21B material 2012A, 2012B can be added on the opposing sides of the raised surfaces on the appliance. This creates spaces for the teeth to move into as the raised surfaces compress and move the teeth. This process is completed without capturing or moving the tooth on the digital file in anyway. Upon fabrication of the aligner of the model with indentations or grooves, a laminate sheet may be used, which adapts into the indentations and becomes raised surfaces.

The CAD Software can be designed so that when an indentation is inserted into the digital file, there is tooth structure added on the opposing side of the digital tooth to allow room for tooth movement when the aligner is inserted over the patient's dentition automatically. For example, if the indentation is placed on the outer portion of a tooth at a depth of 2 mm, then 2 mm is added on the opposing side of the tooth. Upon aligner fabrication, the laminated sheet adapts into the indentation of the digital file and becomes a 2 mm raised surface. Further, since the opposing side of the digital file is also 2 mm thicker, the aligner will have 2 mm of additional room on the opposing side of the raised surface for the tooth to move into during realignment.

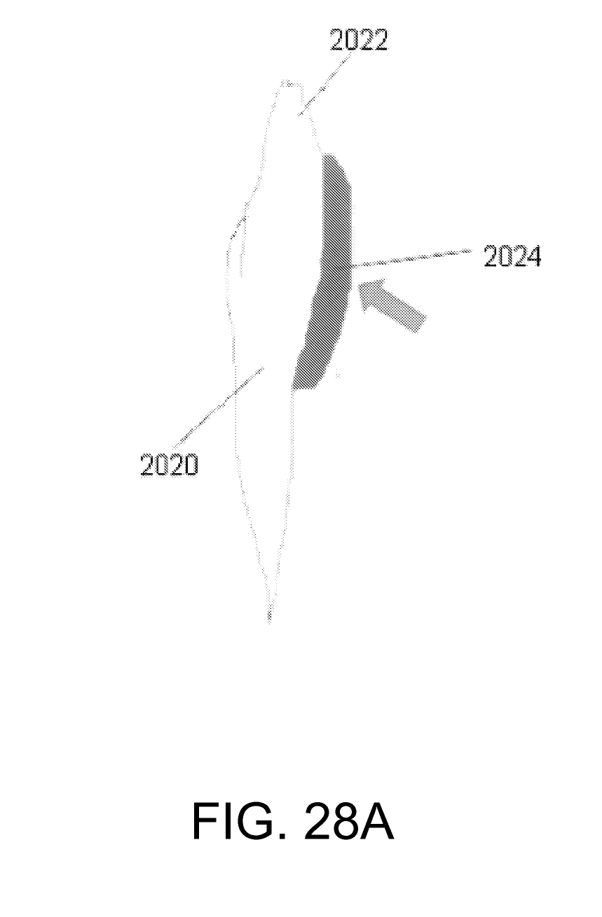

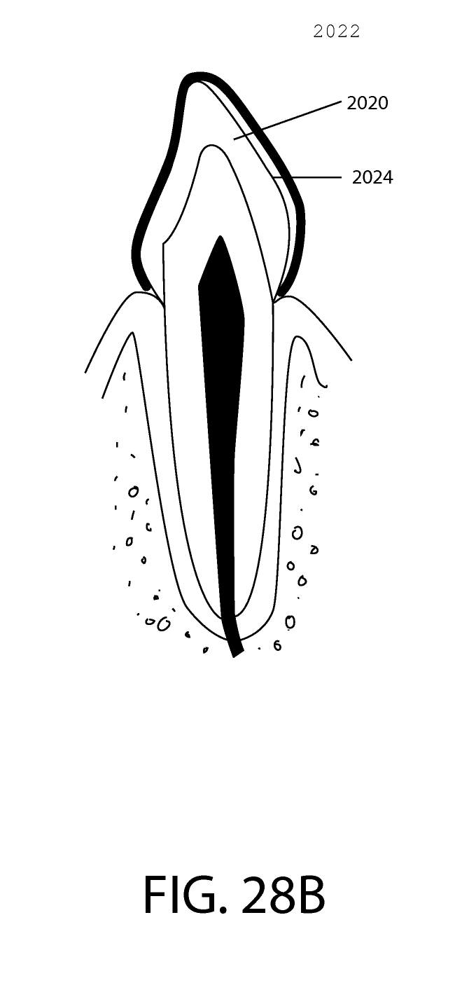

FIGS. 28A and 28B demonstrate a pulling out on the facial aspect 2024 of the tooth on the digital file. The digital file of the patent's dentition 2020 is unaltered at the incisal and gingival margins 2022 to minimize memory relapse by the post orthodontically positioned dentition. The facial aspect 2024 of the tooth is pulled with margins at the incisal, gingival and mesial and distal marginal ridges to allow space for added formulation to be in contact with the teeth.

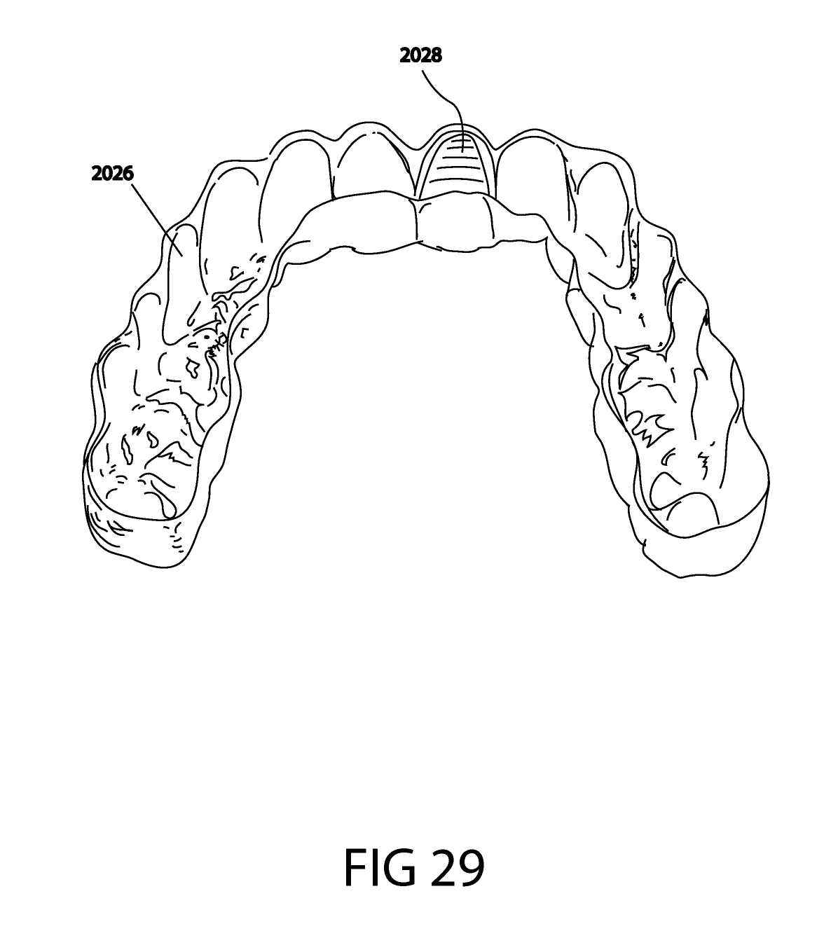

FIG. 29 shows an aligner 2026 formed by the digital file shown in FIG. 28. Upon fabrication of the aligner over this digital file, the internal aspect of the aligner will possess a space 2028 when inserted over the patient's mouth. The space 2028 is sealed at all peripheral margins, and the formulation can be incorporated for interaction with the dentition. This space can be utilized for immersing various formulations such as bleaching material, health and or oral freshness compositions, etc. The formulation can be incorporated into the aligners either by introducing it into the pre-made reservoir or by imbedding it into the laminate material during the manufacturing of the laminate sheet.

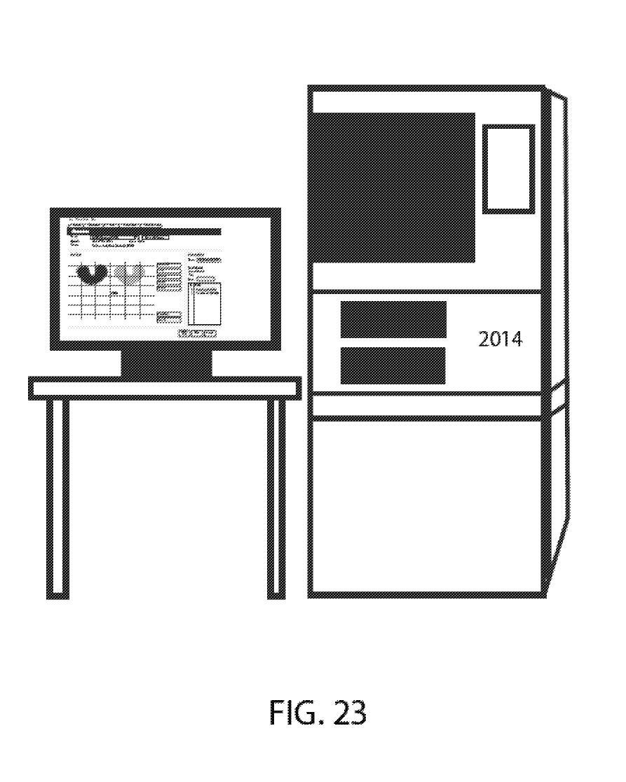

Once the digital file with indentations is created, it is saved and exported as an STL file for printing as a 3D model. The model can be created by a 3D rapid prototyping printer 2014 with the indentations as shown in FIG. 23. However other methods for forming the appliance are contemplated such as 3D scanning, milling, and vacuum suck down.

Additionally the final aligner can act as a retainer and may possess a space for tooth movement. This can be fabricated from the final position of the digital file without any modification and is intended to maintain the position of the teeth in its final stage. Teeth have what is referred to as positional memory. As a result, even though they can be moved, since they have been in their original position for a long duration, they have a tendency to move back to their original position. Therefore, they need to be maintained in the final position for a period of time in the range of 1 to 3 years and sometimes longer in order for the teeth to be habituated to this new position. This is achieved by the use of the final retainer. One or several final retainers can be fabricated for patient's use until the teeth are habituated to the new position. The characteristics of the aligner material will be more rigid than that of the preceding aligners. A further aspect of the final aligner is that in can have added space on the facial aspects of the teeth in the form of reservoirs. This space will allow room for additional composition(s) to be in contact with the dentition for health and or esthetic purposes (e.g., to bleach teeth as a whitening process and or antimicrobial, fluoride and other compositions for bacterial prevention and or to enhance the health of the dentition and oral cavities). In addition, the composition may possess flavoring components such as spearmint and or other known agents for enhanced oral freshness. These materials may be added after the fabrication of the aligners and its associated reservoir or they may be imbedded within the aligner material.

In a further aspect various colors can be added to the aligner to increase visibility of the aligner when it is not in use. In particular, the patient may remove the aligner and not be able to visibly see the aligner if placed on a table top, bathroom sink, restaurant, etc. Providing color to the aligner may aid in helping the patient identify the retainer and prevent against accidental loss, which might otherwise occur if the aligner is clear. Additionally, adding colors to the aligner provides for tracking purposes of the orthodontic phases of treatment. The aligner can be provided with any color such as the patient's favorite color, birthday color, seasonal color, fashion, etc. to help attract greater patient use and enhanced patient compliance. Various colors of orthodontic aligners can be fabricated by using pre-colored sheets if utilizing the rapid prototype 3D printer and vacuum or the aligner can be directly milled from the digital file of the patient's impression. In addition the aligner can be fabricated through the use of a pre-milled polymer blocks, which can possess various colors.

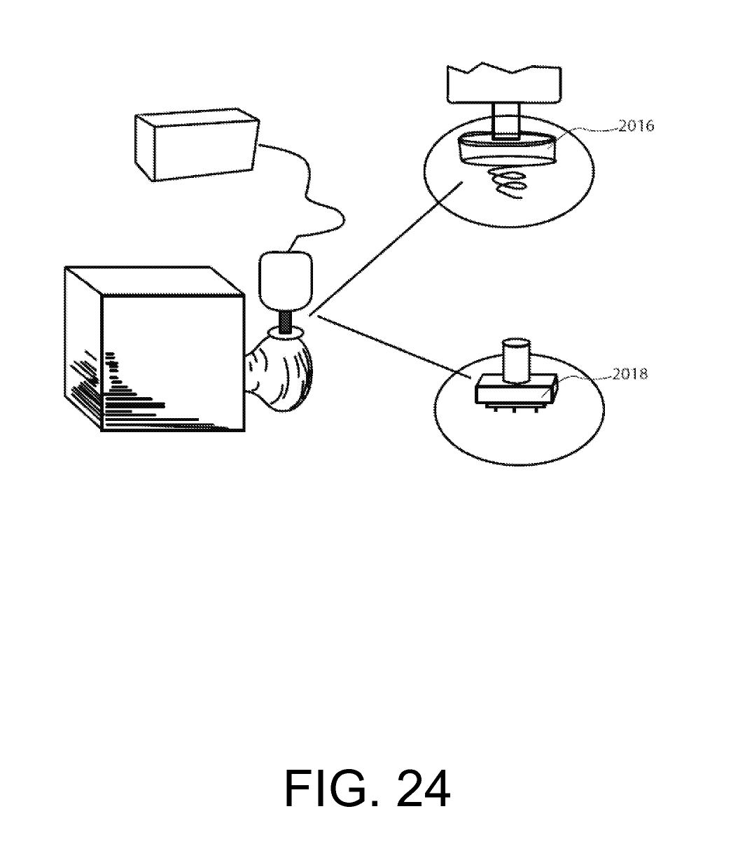

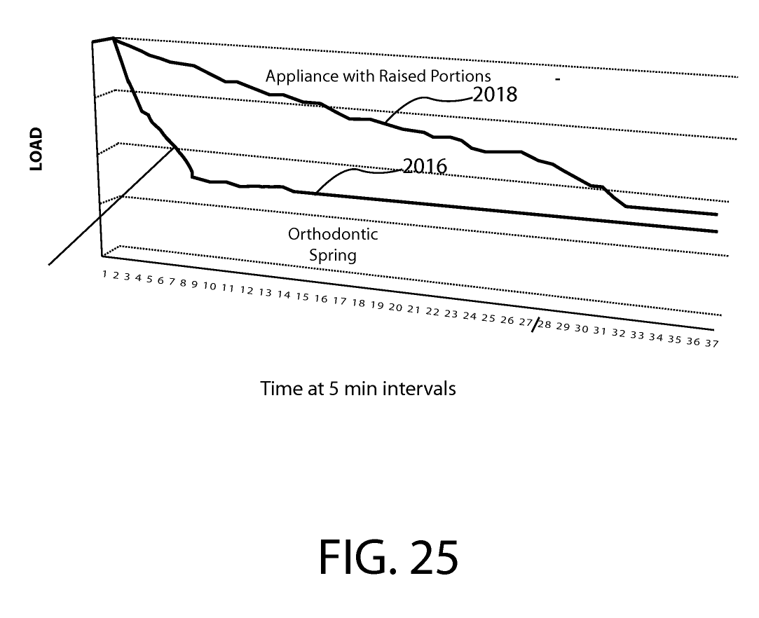

FIG. 24 depicts a schematic diagram comparing the appliance having raised portions 2018 with a conventional dental appliance 2016. FIG. 25 shows a graph comparing a conventional spring 2016 with an appliance 2018 having raised portions. Upon insertion of the aligner over patient's dentition, the raised portions initially compress. Recovery of the raised portions creates force for orthodontic tooth movement. The graph illustrates that the appliance having a raised portion provides a higher force over a longer period of time during the recovery phase than a conventional spring. In other words, the compressible raised portions allow for longer duration of tooth movement at higher levels of force as compared a conventional orthodontic spring.

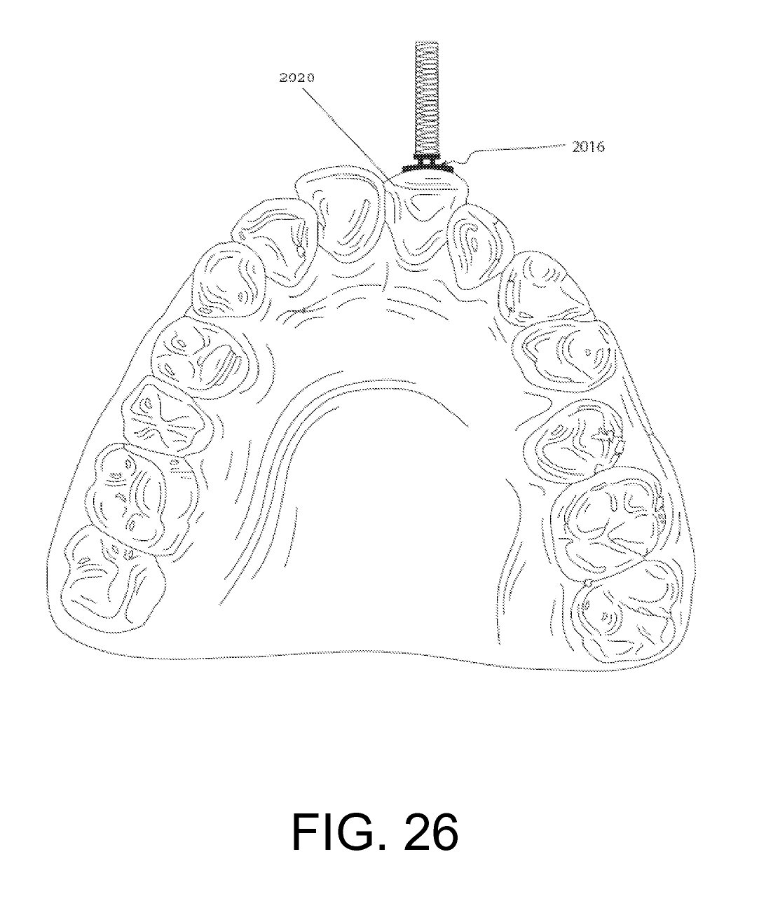

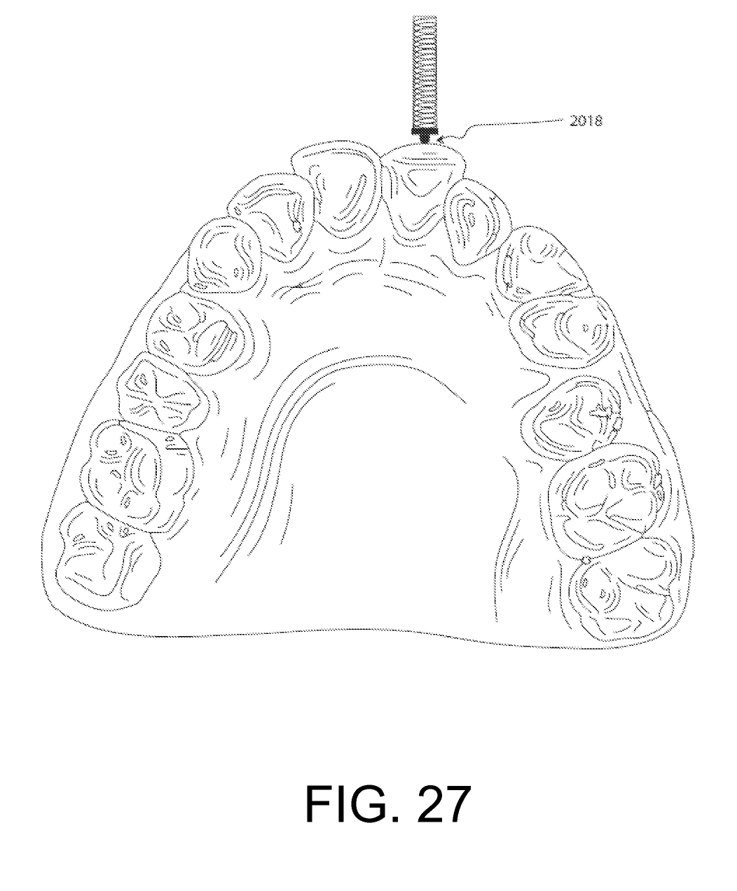

FIG. 26 shows a patient's mouth having a conventional spring 2016 with a bracket 2020 bonded to a tooth. FIG. 27 depicts a patient's mouth where an appliance 2018 with a raised surface is implemented. The use of raised surfaces on an appliance as compared to cementing brackets on patient's teeth may eliminate the need for invasive attachments to teeth such as clasps or brackets. This may provide for better hygiene as clasps or brackets have a tendency to act as traps for bacteria. The use of raised surfaces also provides for improved esthetic appearance for the patient by eliminating unsightly structures on the teeth.

Additionally, the use of raised portions eliminates the need to create an intentional mismatch between an attachment on the tooth and the attachment on the internal aspect of the aligner to cause realignment. The raised surfaces are exact for the desired tooth movement, which translates into more accurate tooth movement. In addition the raised surface can be applied for a longer duration in providing a more flexible internal lining. The raised surfaces may also eliminate the propensity for damage to teeth during application of cement or during grinding of the brackets during removal.

Additionally, the internal lining of the aligner may be formed of a lower modulus of elasticity than the outer shell. The lower modulus material has a tacky, sticky, surface due to its flexible material characteristic. Because of its increased flexibility, the laminate sheet adapts into the digital groove created on the digital file during aligner fabrication. This tacky, flexible characteristic allows greater surface to surface contact which results in lower localized stress and increases the retention of the raised portions to the tooth surface for less slippage when the aligner is inserted over the patient's teeth. This feature may eliminate the need for invasive attachments such as brackets, buttons, nipples, etc.

I claim:

1. An orthodontic repositioning appliance comprising:
an inner layer configured to engage a portion of a patient's teeth;
an outer layer secured to the inner layer; and
wherein the inner layer comprises at least one raised portion which provides increased control and attachment over at least one of the patient's teeth and is configured to compress upon contact with the at least one of the patient's teeth and is configured to recover causing the at least one of the patient's teeth to move.

2. The orthodontic repositioning appliance of claim 1, wherein the inner layer and outer layer comprise elastic moduli in the range of 0.1 to 10.0 GPa.

3. The orthodontic repositioning appliance of claim 1, wherein the outer layer comprises a polycarbonate and the inner layer comprises a thermoplastic polyurethane resin.

4. The orthodontic repositioning appliance of claim 1, further comprising a shape memory alloy.

5. The orthodontic repositioning appliance of claim 1, wherein the repositioning appliance is configured to be attached to a micro-implant to allow for increased control and force for orthodontic tooth movement.

6. The orthodontic repositioning appliance of claim 5, wherein the micro-implant further includes an attachment for securing the repositioning appliance.

7. The orthodontic repositioning appliance of claim 6, wherein the attachment comprises a male-female connection, or a magnet attachment.

8. The orthodontic repositioning appliance of claim 1, wherein the inner and outer layer comprise one or more of: a bacterial resistant material, a teeth whitening material, an oral freshness material, and a varied color material.

9. The orthodontic repositioning appliance of claim 1, wherein the at least one raised portion is selected from the group consisting of: a star shape, a rectangular shape, a circle shape, and a bar shape.

10. The orthodontic repositioning appliance of claim 1, wherein the raised portion consists of one of the following: a lingual vertical bar, a horizontal bar, and a diagonal bar.

11. The orthodontic repositioning appliance of claim 1 wherein the outer layer has a higher elastic modulus than the inner layer and wherein the inner layer comprises a continuous layer having a lower elastic module than the outer layer.

12. A method of repositioning misaligned teeth comprising:
a) taking an impression of the patient's teeth and forming a model based on the impression of the patient's teeth;
b) adding at least one indentation to the model; and
c) creating a repositioning appliance from the model, wherein the repositioning appliance is formed with an inner layer having at least one raised surface corresponding in shape and size to the at least one indentation formed in the model.

13. The method of claim 12 wherein the indentation is selected from the group consisting of: a star shape, rectangular shape, circle shape, and a bar shape.

14. The method of claim 12 wherein step (b) further comprises adding at least one additional indentation to the model of a different shape or size than the at least one indentation and wherein step (c) further comprises forming the appliance with at least one additional raised surface corresponding in shape and size to the additional indentation on the model.

15. The method of claim 12 wherein the repositioning appliance is formed by one or more of: 3D scanning, milling, printing, and vacuum suck down.

16. The method of claim 12 wherein step (b) further comprises adding material in the area opposing the indentation in the model and wherein step (c) further comprises forming a space in the appliance corresponding in shape and size to the added material in the model.

17. The method of claim 14, further comprising repeating steps a) through c) at periodic intervals using at least one different indentation on at least the same or an additional model so as to form at least one different raised surface on an at least one additional appliance.

18. The method of claim 16, wherein the periodic interval comprises six weeks.

19. The method of claim 14, wherein the outer layer comprises a polycarbonate and wherein the inner layer comprises a thermoplastic polyurethane resin.

20. An orthodontic repositioning appliance comprising:
an inner layer configured to engage a portion of a patient's teeth;
an outer layer laminated to the inner layer; and
wherein the inner layer comprises a plurality of raised portions which provide increased control and attachment over at the portion of patient's teeth and wherein the raised portions are configured to compress upon contact with one or more of the patient's teeth and recover causing one or more of the patient's teeth to move to a desired position.
